(19) United States
(12) Patent Application Publication
(10) Pub. No.: US 2006/0020126 A1
(43) Pub. Date: Jan. 26, 2006

(54) Production of microcrystalline cellulose

(76) Inventors: Robert Kopesky, Camden, ME (US); Thomas A. Ruszkay, Hockessin (DE)

Correspondence Address: Paul A Fair;FMC Corporation, Patent Administrator, 1735 Market Street, Philadelphia, PA, 19103, US

(21) Appl. No.: 10/521,886

(22) PCT Filed: Jul. 24, 2003
(86) PCT No.: PCT/US03/22988

§ 371 Date: Jul. 5, 2005

(30) Foreign Application Priority Data
Jul. 26, 2002 (US) 60398803

(51) Int. Cl. C08B 15/06

(52) U.S. Cl. 536/30

(57) ABSTRACT

Microcrystalline cellulose is produced by subjecting to a high shear treatment, at elevated temperature and pressure, a reaction mixture of a cellulose material, an active oxygen compound and water, for a time effective to depolymerize the cellulose material. The mixture may be further depolymerized after the high shear treatment by holding it without cooling. A suitable active oxygen compound is hydrogen peroxide. An extruder is a typical high shear device.

### FIELD OF THE INVENTION

This invention relates to processes for production of microcrystalline cellulose, particularly in simplified, continuous modes, using conventional chemical processing equipment.

### BACKGROUND OF THE INVENTION

Microcrystalline cellulose, also known as MCC or cellulose gel, is commonly used as a binder and disintegrant in pharmaceutical tablets, as a suspending agent in liquid pharmaceutical formulations, and as a binder and stabilizer in food applications including beverages and as stabilizers, binders, disintegrants and processing aids in industrial applications, household products such as detergent and/or bleach tablets, agricultural formulations, and personal care products such as dentifrices and cosmetics. In foods, MCC is used alone or in coprocessed modifications as a fat replacer. The classic process for MCC production is acid hydrolysis of purified cellulose, pioneered by O. A. Battista (U.S. Pat. Nos. 2,978,446, 3,023,104, 3,146,168). In efforts to reduce the cost while maintaining or improving the quality of MCC, various alternative processes have been proposed. Among these are steam explosion (U.S. Pat. No. 5,769,934—Ha et al), reactive extrusion (U.S. Pat. No. 6,228,213 —Hanna et al), one-step hydrolysis and bleaching (World Patent Publication WO 01/02441 —Schaible et al), and partial hydrolysis of a semi-crystalline cellulose and water reaction liquor in a reactor pressurized with oxygen and/or carbon dioxide gas and operating at 100 to 200° C. (U.S. Pat. No. 5,543,511—Bergfeld et al).

In the steam explosion process of Ha et al, a cellulose source material, such as wood chips, is contacted in a pressure reactor vessel with pressurized steam at a temperature of at least about 170° C. for a brief period, concluding with a rapid release of the steam pressure (the “steam explosion” effect). Under these conditions the fibrous, amorphous, portions of the cellulose polymer chains are hydrolyzed, leaving the crystalline segments of the chains which characterize the product as MCC. The hydrolysis can be followed by determination of the extent of depolymerization of the cellulose, to a steady state known as “level off degree of polymerization” (LODP). Typically, according to Ha et al, a starting cellulose will have a degree of polymerization (“DP”) in excess of 1000 and the average DP characteristic of the steam exploded MCC product preferably will be in the range of about 100 to 400. The rapid decompression in the steam explosion process, particularly when effected through a small opening or die, facilitates physical separation of cellulose, hemicellulose and lignin in the source cellulose material. Such separation enables more efficient subsequent extraction of the hemicellulose and lignin. Another advantage of the steam explosion process is that it eliminates need for an acid hydrolysis to achieve the requisite depolymerization. A disadvantage is difficulty in controlling process conditions for optimization of MCC yield and quality. Ha et al disclose that the MCC product may subsequently be bleached with hydrogen peroxide or other reagent.

In the reactive extrusion process of Hanna et al, an acid hydrolysis of cellulose is effected in an extruder at an extruder barrel temperature of about 80-200° C. The action of the extruder screw on the cellulose, probably in conjunction with the elevated temperature, produces a pressure, providing more intimate contact of cellulose and acid. Advantages of the process include shorter reaction times and reduction of the amount of acid solution required for the hydrolysis, from ratios of acid to cellulose of about 5:1 and 8:1, to a ratio of about 1:1, with resultant lesser problem with disposal and environmental impact. However, the residual acid must be neutralized and washed out of the product. After neutralization and washing, the product may be bleached with sodium hypochloride or hydrogen peroxide.

In the one-step process of Schaible et al, hydrolysis and bleaching of cellulose pulp to MCC is combined by reacting the pulp with an active oxygen compound in an acidic environment. The acidic environment is provided either by an active oxygen compound that is also acidic, such as peroxymonosulfuric acid or peracetic acid, or by the presence of an acid, mineral or organic, in the reaction mixture with the active oxygen compound. Optionally, the reaction can be run at elevated temperature and/or pressure. An advantage of the process, in addition to combining bleaching with hydrolysis, is operability on cellulose materials having a wide variety of color values. No reaction equipment, including pressure reactors or extruders, is described.

The hydrolysis process of Bergfeld et al, while having the advantage of reducing the amount of aqueous effluent, is limited to hydrolysis of purified celluloses.

The known processes for MCC production accordingly suffer from one or more of the following disabilities: need to purify or process the cellulose feed material; batch reactions and extended batch reaction times; multiple steps, after hydrolysis, to bleach and to purify the product; low solids reaction mixtures, particularly if a pressure reactor is used, leading to extended reaction time and/or low yields; and high acid to cellulose feed material ratios accompanied by required neutralization and removal for avoidance of environmental damage. These drawbacks, individually or in combination, lower processing efficiency and increase product cost.

### SUMMARY OF THE INVENTION

In accordance with one aspect of the present invention, MCC is produced more efficiently and simply, and therefore at lower cost, by subjecting to a high shear treatment, at elevated temperature, a reaction mixture comprising a cellulose material, an active oxygen compound and water, for a time effective to depolymerize the cellulose material. Preferably, the depolymerization is to an average DP of 400 or less, more preferably 350 or less.

In preferred embodiments of the invention, the active oxygen compound is hydrogen peroxide and the reaction mixture is subjected to the high shear treatment in an extruder system comprising a barrel (having one or more barrel sections) and a product outlet. The outlet generally is fitted with a die and the MCC preferably is produced in fine particle form.

In other aspects of the invention, depending on the character of the cellulose feed material, functional reagents of various types may be added to the reaction mixture or may be present in the feed cellulose material, and/or product MCC may be subjected to one or more modification or finishing steps, such as washing, extraction, pH adjustment, attriting to colloidal particle size, filtering, screening, and drying to powder form.

### DETAILED DESCRIPTION

A wide variety of cellulose materials are useful as feeds in the present invention. The cellulose material may be raw, natural, cellulose materials, such as wood chips or fragments from various sources, such as hardwood and softwood trees, or annual plant growth materials, such as corn, soy and oat hulls, corn stalks, corn cobs, bagasse; and wheat, oat, rice and barley straw. Preferably, the cellulose will be in a divided form, such as chips, fragments, and the like. The cellulose material may also be processed materials such as chemical (sulfite) or mechanical pulp mill products—sheets, rolls, chips, dusts, and the like—whether dry or wet, bleached or unbleached, or may be purified cellulose, such as viscose rayon filaments or cotton linters. Generally, the cellulose will be a dissolving grade cellulose, such as lignocellulose, containing alpha cellulose,. lignin and hemicellulose. Depending on the intended use of the MCC product, the lignin and hemicellulose may be extracted from the cellulose feed material before subjection to the high shear treatment of the invention or extracted from the high shear reaction product after formation of the MCC. Known extraction techniques can be used at either point in the processing. The hemicellulose is conventionally extracted with a hot aqueous solution (about 50-100° C.) which may be alkaline. The lignin is conventionally extracted with a lignin-solubilizing solvent, preferably an alkaline solution or aqueous organic alcohol solution such as aqueous ethanol. Preferred cellulose feed materials are processed mill pulp in dried sheet or roll form or wet, dissolving grade celluloses, purified celluloses, and particulate or fragment celluloses or cotton linters.

Active oxygen compounds useful in the high shear process of the invention are compounds which are non-gaseous at standard temperature and pressure, and include one or more of hydrogen peroxide, peroxy acids, peroxy esters and hydroperoxides; inorganic peroxides such as alkali metal salts of peroxymonosulfuric acid and peroxydisulfuric acid, and the corresponding ammonium and potassium persalts, potassium peroxydiphosphate; salts of peroxymonophosphoric acid, peroxydiphosphoric acid, peroxytitanic acid, peroxydistannic acid, peroxydigermanic acid and peroxychromic acid; and organic peroxides such as sodium peroxymonocarbonate, potassium peroxydicarbonate, peroxyoxalic acid, peroxy formic acid, peroxy benzoic acid, peroxy acetic acid (peracetic acid), benzoyl peroxide, oxaloyl peroxide, lauroyl peroxide, acetyl peroxide, t-butyl peroxide, t-butyl peracetate, t-butyl peroxy pivalate, cumene hydroperoxide, dicumyl peroxide, 2-methyl pentanoyl peroxide, and the like, including mixture of two or more thereof and salts if they exist.

A preferred oxygen compound is hydrogen peroxide, supplied as an aqueous solution. Any concentration can be used, such as commercial grades ranging from about 30 wt % to about 70 wt %. Such solutions are available from many sources, including FMC Corporation, Philadelphia USA. FMC Corporation hydrogen peroxide solutions are sold as Standard, Technical, Super D®, Food (“Durox”™), Semiconductor and other grades, in a range of concentrations differing in purity, acidity and stability. The grades intended for semiconductor, electronic (etching), pharmaceutical, technical (research), NSF and food applications are more acidic than other grades, ranging from about pH 1.0 to 3.0. The grades intended for cosmetic and metallurgical applications have the highest pH, of the order of 4-5, and dilution of any of the grades tends to raise the pH. Except for the Technical grades, the solutions generally contain an inorganic tin stabilizer system. The Standard grades are used in most industrial applications for oxidative bleaching and other oxidations, such as pulp, textile and environmental treatment. A lower pH also contributes to stability; pH can also be lowered by stabilizers, some of which are acidic or can buffer to maintain acidity. The Technical grades are designed for uses requiring essential absence of inorganic metal ions, to avoid residues or precipitates resulting from such ions. The Super D grades meet US Pharmacopia specifications for topical applications and are stabilized with additives to enable users to store dilute solutions for extensive periods. Such solutions are useful for home laundry bleaches and for pharmaceutical and cosmetic applications.

It will be evident that for purposes of the present invention, the oxygen compound, such as hydrogen peroxide solution, should be selected for compatibility with the uses intended for the MCC prepared with the oxygen compound. For example, if residues of the stabilizers present in a hydrogen peroxide solution are undesirable in products in which the MCC will be used, a hydrogen peroxide grade lacking the stabilizers should be employed. Likewise, certain oxygen compounds will be preferred over others, depending on the reactivity of the oxygen compounds in the high shear process of the invention, to avoid undesirable degradation products in the MCC. Such selections can readily be made by those skilled in the art of MCC production.

Suitable equipment to provide the high shear stress and depolymerization in accordance with the invention include media mills designed for elevated temperature and pressure operation and extruders. Media mills include ball, rod and sand mills, and vibratory mills.

Extrusion is a preferred method of high shear stress treatment of the invention because extruders provide both high shear and material conveying in a single machine. Various extruder designs can be used, the choice depending on the desired throughput and other conditions, and will be apparent to those skilled in the art in light of the parameters described herein, including the Examples. Suitable extruders include, but are not limited to, twin-screw extruders manufacturd by Clextral, Inc., Tampa, Fla., Werner-Pfliederer Corp., Ramsey, N.J. and Wenger Manufacturing, Inc., Sabetha, Kans. U.S. Pat. Nos. 4,632,795 and 4,963,033 to Huber et al (Wenger Manufacturing, Inc.) describe typical single-screw extruders. While such extruders may be used in the present invention, twin-screw adaptations are preferred.

The twin-screw extruder screw profile is particularly effective for providing a level of shear which will efficiently expose the amorphous fibrous sections of the cellulose polymer chains, thereby facilitating the depolymerization of the cellulose to the MCC form. For this purpose the screws typically are mounted in a barrel and comprise a plurality of high shearing sections, for example five such sections, made up of conveying elements, mixing blocks, and reverse elements for several, for example three, of the high shear sections. The conveying elements transport the reaction mixture and MCC product along the extruder. The reverse elements increase the residence time of the reaction mixture in the mixing blocks, where some shearing occurs. A die plate is typically attached to the extruder outlet.

The reaction mixture of cellulose material, active oxygen compound and water may be formed in the high shear device by separate or simultaneous injection but preferably is preformed in a mixing vessel (premixer), such as a ribbon blender or feeder extruder, to obtain good contact between the cellulose material and active oxygen compound, the reaction mixture then being transported into the high shear device. If not supplied as an aqueous solution, the active oxygen compound normally will be dispersed or dissolved in water and added to the cellulose material in the premixer, or the cellulose material added to the active oxygen compound solution in the premixer. Typically, the active oxygen compound is hydrogen peroxide, supplied as a 35 to 70 wt % solution and then diluted as desired, either prior to admixture with the cellulose material or by addition of water to the mixture of hydrogen peroxide solution and cellulose material. When the high shear device is an extruder, the hydrogen peroxide solution will be diluted during the premix step, typically to provide about 0.1 to 10 wt %, preferably about 0.5 to 5 wt %, of hydrogen peroxide (100% active basis) on total reaction mixture of cellulose material, hydrogen peroxide and water. The solids in the resulting reaction mixture will be adjusted for the high shear device design, speed and desired throughput rate. For example, in a twin screw extruder operating at about 200-600 rpm, the solids may range from about 25 to 60%, preferably about 30 to 50%. Higher solids are preferred, of course, for more efficient reaction, shorter residence time, and higher yield of MCC.

The reaction mixture during the high shear treatment generally will heat internally to an elevated temperature, of the order of at least about 40° C., but heat may also be applied externally, or the temperature conveniently controlled, by heat exchange jacketing of sections of the high shear device, for example, of an extruder barrel. Pressure will be a function of the temperature and screw configuration and is controlled in a known manner by screw speed, throughput rate and outlet design, including die design. Suitable temperature and pressure ranges for an extruder are about 40-160° C. (measured on the barrel), and at least about 20 psi, for example about 40-1500 psi (measured at the outlet), respectively. A preferred temperature range is about 50 to 110° C., more preferably about 90 to 105° C. A suitable extruder screw speed is about 300 to 500 rpm but may be adjusted as required. The residence time of the reaction mixture in the extruder will depend on the process parameters described above, and generally will be short, of the order of about 15 minutes or less, preferably 5 minutes or less.

If desired, the high shear device may be fitted for steam or water injection, for control of reaction mixture solids and other reaction parameters, such as temperature and reaction rate. Steam injection and pressurization, as described in U.S. Pat. No. 5,769,934, may optionally be used in conjunction with the process of the present invention. The high shear depolymerization process of the present invention may also be enhanced by the addition of acidic materials, as described in U.S. Pat. No. 6,228,213.

The depolymerization reaction can be followed by analysis of product for degree of polymerization (DP) and viscosity, relative to DP and viscosity of cellulose material used as feed to the process, in a known manner. Generally, an average DP of about 400 or less, as compared to an initial DP of 1000 or more, indicates significant MCC production; preferably, the process is continued to an DP of 350 or less, more preferably to 250 or less, or as is required to satisfy regulatory requirements, for example of the National Formulary (NF) if product MCC is intended for pharmaceutical tableting, or of the Food Chemical Codex for food, oral care, cosmetic or other applications. The depolymerization reaction can also be followed by pH measurements. Generally, as the reaction proceeds the pH decreases, for example from about 8 to 2. A pH of less than 2 generally indicates overreaction, characterized by significant decomposition of the MCC to glucose or other byproduct.

The residence time in the high shear device may be sufficient to depolymerize to the desired level. In another aspect of the invention, depolymerization of the cellulose material is initiated within the high shear device and the depolymerization reaction continues after exiting from the device for a time sufficient until the desired final degree of polymerization is achieved.

While not fully understood, it is possible that the depolymerization effected by the high shear treatment of the invention is an oxidation reaction rather than an acid hydrolysis because, although certain of the active oxygen compounds are inherently acidic or contain acidic residues from manufacture, the treatment appears to be effective independently of acidification. With certain cellulosic materials the degree of polymerization achieved is lower than was possible with prior art acid hydrolysis processes.

The product MCC can be used as is for some applications, particularly if an outlet die is used which produces a particulate material. Generally, however, the depolymerized product will be in wet particle or wet cake form and will be further refined or finished by one or more steps, including washing, extraction (of hemicellulose and/or lignin in some cases, by known methods), pH adjustment, particle size reduction including attriting to colloidal size, filtering, screening, drying to a powder form (by spray, flash or pan drying), and other operations for purification or modification.

Various additives can be introduced into the reaction mixture (before, during or after reaction) or as part of further processing or finishing, for enhancements. The appropriate point to introduce a specific additive into the process will depend upon its chemical nature including its reactivity with the active oxygen compound, if present, and the desired enhancement. Inorganic particles such as silica or titanium dioxide may be incorporated to facilitate attrition or to modify the functionality or processing properties of the recovered MCC product. Barrier materials such as natural gums or synthetic hydrocolloids (e.g., sodium carboxymethylcellulose) can be added to facilitate colloidal MCC particle formation or to produce modified MCC for use in foods including beverages. Other additives include chemically modified cellulose, seaweed extracts (such as carrageenan), proteins, starches, modified starches, dextrins, sugars, surfactants, emulsifiers, salts, and any mixtures of two or more thereof.

The invention is further described in the following non-limiting Examples. Throughout the Examples and elsewhere in this specification and claims, and unless the context indicates otherwise, all parts and percentages are by weight, all temperatures are centigrade and all pressures are psi or bars (where 1 bar=14.504 psi).

### EXAMPLES

Test Methods

Average particle size was determined by interpolation at 50% for a log normal plot of cumulative weight of powder sized by sieving using the weight of powder retained on sieves of the following mesh size (diameter openings): 500 mesh (28 micron); 400 mesh (37 micron); 325 mesh (44 microns); 200 mesh (75 microns); 100 mesh (150 microns) and 70 mesh (200 microns).

Tablets were prepared using a Carver tablet press and 11.1 mm standard concave tooling with a level powder fill and a constant vertical displacement providing the compression force. The tablet properties including weight, thickness and hardness are mean values for 10 tablets. Tablet hardness was measured using a computerized Tablet Tester 6D (Dr Schleuniger Pharmatron Inc, Manchester N.H.). Disintegration time was measured as the time required for complete disintegration of six tablets placed in a wire mesh basket and dunked within a deionized water bath at 37° C. as described in the Disintegration in the Physical Test and Determinations section (701) of The United States Pharmacopeia, 25^{th} edition, 2001, the United States Pharmacopeial Convention, Inc.

Degree of polymerization (DP), bulk density, conductivity (IC), pH, water soluble substances, and residue on ignition were determined according to the standard test methods defined in the official monograph for microcrystalline cellulose in the National Formulary, 20^{th} edition, 2001, the United States Pharmacopeial Convention, Inc.

### Example 1

Commercially available high alpha dissolving grade softwood pulp with a DP of about 1250 was diced to facilitate material handling. An extruder feed mixture containing 46.4% pulp chips (about 10 mm by 5 mm by 1 mm in size), 1.62% hydrogen peroxide (100% active) and the balance water to make 100 wt % was prepared by combining 35.83 kg of chips and an aqueous hydrogen peroxide solution containing 3.4 kg of technical grade hydrogen peroxide (35% active) and 35.83 kg of water followed by mixing for 15 minutes in a ribbon blender. This mixture was fed at 45 kg/hour into a Wenger TX-57 co-rotating twin screw extruder having four jacketed barrel sections (12 inches length each), which was running at a shaft speed of 400 rpm with a barrel jacket temperature profile along the sections of 18° C./33° C./90° C./70° C. without addition of steam and a temperature at the discharge head of 45° C. Residence time was approximately 2 minutes. The unit was fitted with a two hole die, 2 mm for each hole. The white powder discharged under pressure was steadily blown out of the die and had a DP after drying of 168.

The depolymerized cellulose product recovered from the extruder was mostly non-fibrous and similar in appearance to depolymerized cellulose produced by traditional acid hydrolysis when an aqueous dispersion at 1 to 2% solids was viewed in the microscope under polarized light. Samples of the depolymerized cellulose materials were converted to powder by either spray drying or tray drying followed by grinding. Depolymerized cellulose prepared using commercial acid hydrolysis was used as a control. The spray dried samples were dried in a 3 foot Bowen sprayer dryer with an inlet temperature of 160° C. and an outlet temperature of 102 C. The tray dried samples were dried in an atmospheric oven for 24 hours at 50° C. and then ground to pass through a 60 mesh sieve.

The dried depolymerized cellulose materials were evaluated for tableting performance properties, such as tablet hardness and disintegration, as compared to commercial grades of microcrystalline cellulose and powdered cellulose. The results are shown in Table 1 following.

TABLE 1
Tablet Properties

| | | | | | |
|---|---|---|---|---|---|
| | Average | | | | Disinte- |
| | Particle | Tablet | Tablet | Tablet | gration |
| | Size | weight | thickness | hardness | time |
| Sample | (microns) | (mg) | (mm) | (kp) | (seconds) |

MCC by hydrogen peroxide depolymerization of cellulose

| | | | | | |
|---|---|---|---|---|---|
| Spray dry | 40 | 450 | 6 | 7 | 60 |
| Tray dry - | 140 | 400 | 6 | 1 | 13 |
| 60 mesh | | | | | |
| Tray dry - | 140 | 400 | 5 | 8 | 150 |
| 60 mesh | | | | | |
| Tray dry - | 140 | 400 | 4 | 13 | 300 |
| 60 mesh | | | | | |

MCC by acid hydrolysis of cellulose (“control”)

| | | | | | |
|---|---|---|---|---|---|
| Spray dry | 40 | 475 | 6 | 12 | 1 |

Commercial MCC

| | | | | | |
|---|---|---|---|---|---|
| AVICEL | 20 | 350 | 5 | 1 | 300 |
| PH-105 | | | | | |
| AVICEL | 45 | 475 | 5 | 12 | 69 |
| PH-101 | | | | | |
| AVICEL | 80 | 450 | 6 | 11 | 42 |
| PH-102 | | | | | |
| AVICEL | 180 | 550 | 5 | 32 | 90 |
| PH-200 | | | | | |

Commercial Powdered Cellulose

| | | | | | |
|---|---|---|---|---|---|
| Solka-Floc | 45 | 300 | 3 | 6 | 600 |
| 40 NF | | | | | |

It can be seen that the tablet properties of the products of Ex. 1 closely approximated the properties of commercial MCC.

### Example 2

Additional depolymerized cellulose product was produced in two separate trials using the extruder system of Example 1 and an extruder feed mixture of 55% pulp chips, 0.96% hydrogen peroxide (100% active) and the balance water to make 100 wt % prepared by combining 24.95 kg of chips and an aqueous peroxide solution containing 1.18 kg of technical grade hydrogen peroxide (35% active) and 19.23 kg of water followed by mixing for 15 minutes in a ribbon blender. The extruder feed mixture was fed to the Wenger TX-57 twin screw extruder at a rate of 50 kg/hour. Residence time in the extruder was about 2 minutes. The extruder was operated with a shaft speed of 500 rpm, barrel temperature profiles of 50° C./80° C./100° C./105° C. and 60° C./80° C./100° C./105° C., respectively, with stream injection at 16 kg/hour and 17 kg/hr, respectively, into the jacketed sections of the barrel, a temperature at the discharge head of 70° C. and a discharge pressure of 3 bar at the die exit. The white powder discharged from the die as an aerosol had a DP of less than 200 after drying.

Samples of the depolymerized cellulose product from these two extruder trials were combined and further processed to evaluate the impact of alternative drying conditions. The microcrystalline cellulose from the hydrogen peroxide depolymerized cellulose pulp and the microcrystalline cellulose from acid hydrolyzed cellulose pulp (“control”) were dried using the following processes: (1) spray drying as a slurry with an inlet air temperature of 160° C. and an outlet temperature of 102° C.; (2) tray-drying for 24 hours at 50° C., followed by grinding and sieving to produce a sample with a particle size to less than 60 mesh; and (3) flash drying and grinding to produce a sample with a particle size of less than 60 mesh.

The physical property data are summarized in Table 2 for samples of microcrystalline cellulose produced by hydrogen peroxide depolymerization (Examples 1 and 2) and compared to the microcrystalline cellulose “control” produced by traditional acid hydrolysis.

TABLE 2
Physical Property Summary

| | | Average | Bulk | | | | % water | % residue |
|---|---|---|---|---|---|---|---|---|
| Sample | | Particle Size | Density | | | | soluble | on |
| number | Description | (microns) | (g/cc) | DP | pH | IC | substance | ignition |
| 1 | Ex 1 - 3 ft Bowen SD | 35 | 0.32 | 168 | 2.5 | 620 | 2.81 | 0.24 |
| 2 | Ex 2 - 3 ft Bowen SD | 30 | 0.32 | 187 | 4.8 | 275 | 0.97 | 0.12 |
| 3 | Ex 2 - 8 ft Bowen SD | 35 | 0.32 | 184 | 5.0 | 320 | 0.97 | 0.15 |
| 4 | Ex 2 - tray dry/grind | 70 | 0.32 | 185 | 2.8 | 290 | 2.13 | 0.15 |
| 5 | Ex 2 - flash dry/grind | 95 | 0.32 | 194 | 2.8 | 263 | 1.31 | 0.06 |
| 6 | Control - 3 ft Bowen SD | 35 | 0.36 | 218 | 6.0 | 51 | 0.16 | 0.03 |
| 7 | Control - 8 ft Bowen SD | 45 | 0.36 | 220 | 4.9 | 85 | 0.21 | 0.02 |
| 8 | Control - tray dry/grind | 45 | 0.55 | 200 | 3.1 | 135 | 0.28 | 0.05 |
| 9 | Control - tray dry/grind | 100 | 0.52 | 258 | 3.1 | 114 | 0.20 | 0.05 |
| 10 | Control - flash dry/grind | 40 | 0.45 | NT | 3.1 | 135 | NT | NT |
| 11 | Control - flash dry/grind | 95 | 0.52 | NT | 3.1 | 99 | NT | NT |

“NT” — not tested

It will be evident from Table 2 that the DP of MCC produced by the more environmentally friendly process for depolymerization of cellulose using hydrogen peroxide, in accordance with the invention, is comparable to DP of MCC produced by traditional acid hydrolysis. Traditional finishing steps such as extraction, washing, pH modification etc. can be used to adjust the physical properties of the microcrystalline cellulose for purity, pH etc., in a manner well known to those skilled in the art.

### Example 3

Commercially available high alpha dissolving grade softwood pulp was diced to facilitate material handling. An extruder feed mixture containing 50% pulp chips (about 10 mm by 5 mm by 1 mm in size), 7% hydrogen peroxide (100% active) and the balance water to make 100 wt % was prepared by combining 50 kg of chips and an aqueous hydrogen peroxide solution containing 21.8 kg of technical grade hydrogen peroxide (35% active) and 28.2 kg of water followed by mixing for 15 minutes in a ribbon blender. This mixture was fed at 62 kg/hour into a Wenger TX-57 co-rotating twin screw extruder having four jacketed barrel sections (12 inches length each), which was running at a shaft speed of 450 rpm with a barrel jacket temperature profile along the sections of 80° C./98° C./144° C./137° C. without addition of steam and a product temperature at the discharge head of 82-92° C. Residence time was approximately 2 minutes. The unit was run without a discharge exit die.

The wet pulp mass discharged from the extruder was collected into a covered container and allowed to continue to react. The temperature of the pulp continued to increase to a final temperature of around 109° C. Total reaction time after exiting the extruder was about 15 minutes.

The extruder processed depolymerized cellulose product was mostly non-fibrous and similar in appearance to depolymerized cellulose produced by traditional acid hydrolysis when an aqueous dispersion at 1 to 2% solids was viewed in the microscope under polarized light. The final depolymerized cellulose product had a DP of 116 compared to the starting pulp with a DP of approximately 1250.

### Example 4

The reacted wet pulp product from Example 3 was fed into a Wenger X85 single screw extruder equipped with 5 barrel sections and steam and water injection. The shaft speed was 500 rpm and the extruder discharge rate was 210 kg/hr through a single hole throttle die. Pressure at the die was 1379 kPa (200 psi). Moisture content of the feed was 25.5 wt %. Moisture content of the product was 45.1 wt % at the exit.

The material at the discharge of the single screw extruder was air conveyed into drums. The depolymerized cellulose product recovered had a DP of 113.

### Example 5

The materials recovered from Examples 3 and 4 were washed with deionized water in an 18 inch diameter basket centrifuge spinning at 1160 rpm. Details of the washing process are shown in the following table:

TABLE 5A

| | Unwashed | Unwashed | Wash | Washed | Washed |
|---|---|---|---|---|---|
| | Sample | Sample | water, | Sample | Sample |
| Sample ID | solids, % wt. | weight, lb. | gal. | weight, lb. | solids, % wt. |
| 3W (From | 80 | 42 | 25 | 101 | 33 |
| Ex. 3) | | | | | |
| 4W (From | 55 | 120 | 27 | 162 | 40 |
| Ex. 4) | | | | | |

The washed materials were combined with 15% wt on a dry basis 7MF grade sodium carboxymethylcellulose (from Hercules Inc., Wilmington Del.) in a Hobart mixer. The cellulose/CMC mixtures were then mechanically attrited in a high shear extruder to produce colloidal cellulose particles less than 0.2 microns in size. The attrited samples were then spray dried or tray dried and ground for testing. Table 5B shows the properties of the dried attrited materials compared to a typical commercial product produced from high alpha dissolving grade softwood pulp depolymerized by acid hydrolysis and a Control prepared from a high alpha dissolving grade hardwood pulp depolymerized by acid hydrolysis. It can be seen that the materials resulting from the process of the present invention show properties approaching those achieved with a more costly, more highly treated pulp of the Control. Colloidal Content (i.e., weight percent less than 0.2 microns) was determined by centrifugation at 8250 rpm for 15 minutes followed by gravimetric analysis of the dried supernatant product.

TABLE 5B

| | Spray dried | | | | | | |
|---|---|---|---|---|---|---|---|
| | Commercial | | | | | | |
| | product | | | | Bulk dried | | |
| | (typical) | Control | 3W-attrited | 4W-attrited | Control | 3W-attrited | 4W-attrited |
| Powder sieve fraction, | | 10 | 2.5 | 2.3 | 50 | 48 | 41 |
| % wt + 200 mesh | | | | | | | |
| Powder sieve fraction, | | 10 | 8.4 | 0.7 | 70 | 76 | 74 |
| % wt + 325 mesh | | | | | | | |
| Colloidal Content - | 35 | 75.6 | 57.7 | 67.7 | 67.8 | 61.1 | 60.7 |
| % wt less than 0.2 micron | | | | | | | |

1. A process for producing microcrystalline cellulose, comprising subjecting to a high shear treatment at elevated temperature, a reaction mixture comprising a cellulose material, an active oxygen compound and water for a time effective to depolymerize the cellulose material

2. The process of claim 1 wherein the cellulose material is depolymerized to an average degree of polymerization of 400 or less.

3. The process of claim 1 wherein the active oxygen compound is hydrogen peroxide and the reaction mixture is subjected to the high shear treatment in an extruder system including a barrel and a product outlet.

4. The process of claim 3 wherein the elevated temperature during the high shear treatment is at least about 40° C. as measured on the barrel.

5. The process of claim 3 wherein the elevated temperature during the high shear treatment is at least about 40° C. to 160° C. as measured on the barrel.

6. The process of claim 3 wherein the elevated temperature during the high shear treatment is at least about 50° C. to 110° C. as measured on the barrel.

7. The process of claim 3 wherein the elevated temperature during the high shear treatment is at least about 90° C. to 105° C. as measured on the barrel.

8. The process of claim 3 wherein pressure at the product outlet is in the range of about 20 to 1500 psi.

9. The process of claim 3 wherein the hydrogen peroxide comprises an aqueous solution and is admixed with the cellulose material prior to introduction of the cellulose material to the extruder system.

10. The process of claim 3 wherein the hydrogen peroxide comprises an aqueous solution and is introduced into the extruder system after introduction of the cellulose material.

11. The process of claim 9 wherein the cellulose material comprises processed mill pulp, dissolving grade cellulose, purified cellulose, or dry cellulose in sheet or divided form.

12. The process of claim 10 wherein the cellulose material comprises processed mill pulp, dissolving grade cellulose, purified cellulose, or dry cellulose in sheet or divided form.

13. The process of claim 3 wherein the extrusion system comprises a twin-screw extruder.

14. The process of claim 3 wherein the extrusion system comprises a twin-screw extruder, the cellulose material comprises about 30% to about 50% by weight of the reaction mixture, and the hydrogen peroxide comprises about 0.1% to about 10% by weight of the reaction mixture, on a 100% active basis of hydrogen peroxide.

15. The process of claim 14 wherein the pH of the reaction mixture during extrusion is in the range of about 2 to 8.

16. The process of claim 14 wherein the extrusion is continuous and residence time is 15 minutes or less.

17. The process of claim 14 wherein the extrusion is continuous and residence time is 5 minutes or less.

18. The process of claim 3 wherein the reaction mixture includes an additive added before, during or after the high shear treatment.

19. The process of claim 18 wherein the additive is selected from a cellulose different from the cellulose material, a chemically modified cellulose, a seaweed extract, a natural gum, a protein, a synthetic hydrocolloid, starches, modified starches, dextrins, sugars, surfactants, emulsifiers, salts, and any mixtures of two or more thereof.

20. The process of claim 1 wherein the product is subjected to one or more finishing steps selected from washing, extraction, pH modification, attriting, filtering, screening, and drying to a powder form.

21. The process of claim 1 wherein the finishing steps include washing, attriting to colloidal particle size, and drying to powder form.

22. The microcrystalline cellulose produced by the process of claim 1.

23. The microcrystalline cellulose produced by the process of claim 3.

24. The microcrystalline cellulose produced by the process of claim 14.

25. The microcrystalline cellulose produced by the process of claim 19.

26. The microcrystalline cellulose produced by the process of claim 20.

27. The microcrystalline cellulose produced by the process of claim 21.

28. The process of claim 1 wherein, following the high shear treatment, the reaction mixture is held for a time effective to further depolymerize the cellulose material.

29. The process of claim 20 wherein the finishing step is attriting.

30. The process of claim 29 wherein the material is combined with an additive selected from a cellulose different from the cellulose material, a chemically modified cellulose, a seaweed extract, a natural gum, a protein, a synthetic hydrocolloid, starches, modified starches, dextrins, sugars, surfactants, emulsifiers, salts, and any mixtures of two or more thereof and the combination is attrited.

31. The process of claim 30 wherein the additive is carboxy methyl cellulose.
